(19) United States
(12) Patent Application Publication
(10) Pub. No.: US 2019/0285304 A1
(43) Pub. Date: Sep. 19, 2019

(54) INTEGRATED SMART DEVICE AND WIRELESS ACCESS POINT

(71) Applicant: Garrin Scott FELBER, Austin, TX (US)

(72) Inventor: Garrin Scott FELBER, Austin, TX (US)

(21) Appl. No.: 15/921,127

(22) Filed: Mar. 14, 2018

(51) Int. Cl. F24F 11/56; H04W 72/04; G01K 1/02; G01K 13/00; F24F 11/88

(52) U.S. Cl. CPC F24F 11/56; H04W 72/0406; H04W 88/08; G01K 13/00; F24F 11/88; G01K 1/024

(57) ABSTRACT

A device, access point and system for integration of a smart device and a wireless access point (AP) are provided. According to one aspect, a smart device is configured to enable remote control of an attribute of the smart device; and a wireless access point is configured to relay data packets to and from the Internet and to and from a wireless station, such as another smart device. In one embodiment, the smart device is a thermostat and the wireless access point (AP) is configured to transmit temperature control signals to climate control equipment and to receive and transmit voice signals from and to a terminal device. The AP 3 includes a thermostat configured to measure temperature. The AP also includes a processor configured to generate temperature control signals based on the measured temperature, the temperature control signals to be communicated to the climate control equipment. The AP further includes a radio transceiver configured to receive and transmit voice signals from and to a terminal device.

### TECHNICAL FIELD

The present invention relates to a method and system for integration of a smart device such as a smart thermostat and a wireless access point (AP).

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a wireless/wireline system within a building for generating temperature control signals at a wireless access point and for combining an access point with a smart device.

### DETAILED DESCRIPTION

Before describing in detail exemplary embodiments, it is noted that the embodiments reside primarily in combinations of apparatus components and processing steps related providing temperature control at a wireless access point and communicate temperature information over power lines to a communication device configured to deliver temperature information to the Internet. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

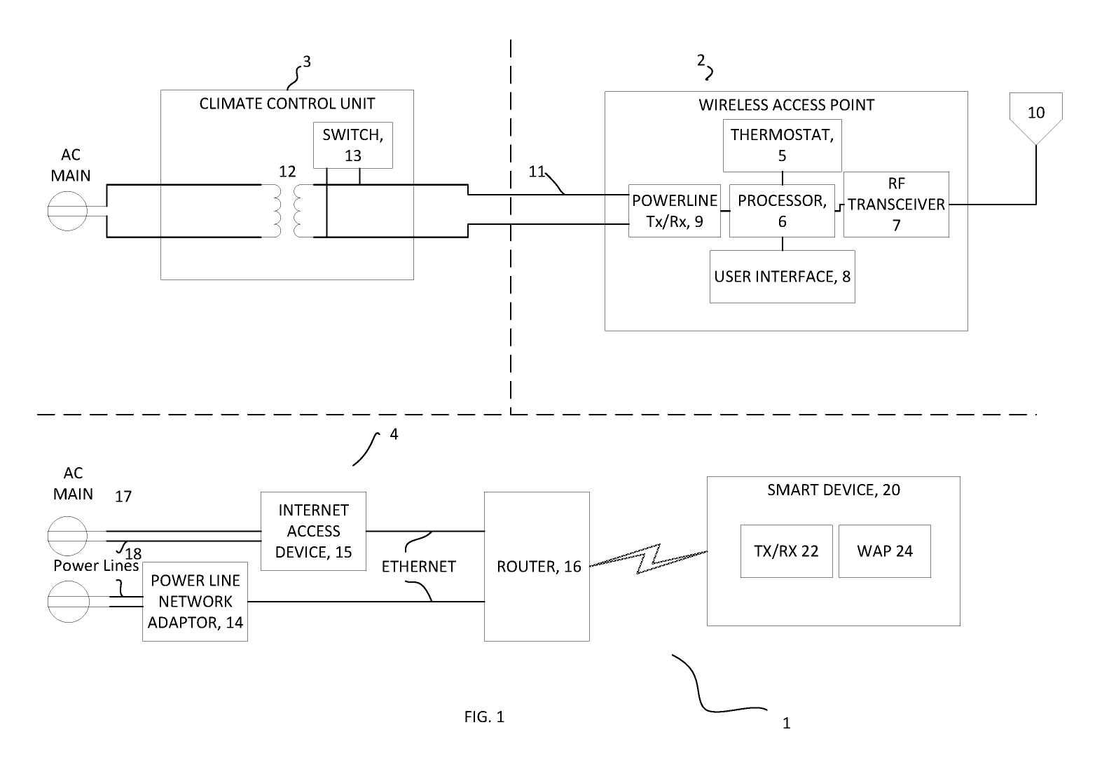

FIG. 1 is a block diagram of an in-building wireless/wireline system 1 including a wireless access point (AP) 2, a climate control unit 3 such as a furnace and/or air conditioning unit, and networking electronics 4. The wireless AP 2 may be a Wi-FI access point that is configured to route network data between the wireless and wireline connections. In some embodiments, the AP 2 has a thermostat 5 that is configured to control temperature by controlling the on/off state of the climate control unit 3. The AP 2 also has a processor 6, an RF transceiver 7, a user interface 8, a powerline interface 9 and an antenna 10. A purpose of the AP 2 is to facilitate wireless communications with terminals within the building/home such as wireless telephones, i-Pads, tablets, computers, etc., via the antenna 10. The AP 2 communicates with the Internet and/or a public switched telephone network (PSTN) via wireline or wirelessly via a router 16 and thereby provides two way communication of network data such as voice data. The AP 2 may also advertise its presence to terminals within the building/home such as smart device 18. The AP 2 may conform to IEEE 802.11 Wi-Fi standards. To this end, the processor 6 may process information signals to be transmitted by the antenna 10 and to be received by the antenna 10. The processor may also process a measured temperature from the thermostat and generate temperature control signals. The RF transceiver 7 may up convert a baseband signal to be transmitted via the antenna 10 to a radio frequency (RF) signal and may down convert a RF signal received via the antenna 10 to a baseband signal to be processed by the processor 6. The RF transceiver 7 also amplifies the received signal and amplifies the signal to be transmitted.

The user interface 8 enables a user to instruct the processor 6 to perform and facilitate various functions such as generating temperature control signals to control the temperature of the building/home via the climate control unit 3. For example, the user interface 8 may receive a temperature setting to be compared by the processor 6 to the temperature measured by the thermostat 5 to generate the temperature control signals. The temperature control signals from the processor 6 are sent from the AP 2 to the climate control unit 3 over an electrical wireline 11 via the powerline interface 9. The powerline interface 9 impresses temperature control signals from the processor 6 onto the electrical wireline 11 to control the climate control unit 3.

A typical climate control unit 3 may have a transformer 12 to couple a low voltage signal to a higher voltage signal to be coupled to the Alternating Current (AC) main powerlines of the building/home to which the climate control unit 3 is connected. In this way network data and/or thermostat control signals carried on the electrical wire line 11 can be carried on the powerlines of the building to the networking electronics 4. In some embodiments, the temperature control signals are coupled from electrical wireline 11 to a switch 13 of the climate control unit 3 to control the on/off status of the climate control unit 3. In some embodiments, the temperature control signals may further control a speed or rate of heating or cooling by the climate control unit 3 by, for example, controlling the speed of a fan of the climate control unit 3.

The networking electronics 4 may include a network adapter 14, an Internet access device 15, such as a cable/digital subscriber line (DSL) modem, and a router 16. The network adapter 14 and/or the cable/DSL modem 15 may be plugged into an electrical outlet 17, thereby receiving the network data and/or temperature control signals placed on the AC powerline via the climate control unit 3. A purpose of the Internet access device 15 is to convert cable, T1, DSL line or fiber signals to signals that may be distributed about the building/home via the router 16. Similarly, the network adapter 14 allows computers to communicate over a computer network using cables, such as Ethernet, or wirelessly. The Ethernet network may conform to IEEE 802.3 standards. The Internet access device 15 and/or the powerline network adapter 14 may detect the temperature control signals on the AC main powerlines and communicate these signals to the router 16, and may also communicate the temperature control signals to the Internet. Thus, placing the thermostat in the AP 2 enables the temperature control signals to be carried to the Internet via the building/home power lines and electrical cables 18.

Thus, according to one aspect, a wireless access point (AP) 2 is configured to transmit temperature control signals to climate control equipment 3 and to receive and transmit voice signals from and to a terminal device. The AP 2 includes a thermostat 5 configured to measure temperature. The AP 2 also includes a processor 6 configured to generate temperature control signals based on the measured temperature, the temperature control signals to be communicated to the climate control equipment 3. The AP 2 further includes a radio transceiver 7 configured to receive and transmit voice signals from and to a terminal device. The AP 2 may also communicate via wireline to the Internet.

According to this aspect, in some embodiments, the AP 2 also includes a user interface 8 adapted to enable input of a temperature setting and wherein the processor 6 is further configured to compare the temperature setting to the measured temperature to generate the temperature control signals. In some embodiments, the AP 2 further includes a powerline interface 9 configured to couple the temperature control signals to the climate control equipment 3. In some embodiments, the powerline interface 9 is further configured to couple electrical power to the AP 2. In some embodiments, the powerline interface 9 is further configured to place the temperature control signals on an alternating current (AC) power line 11 that powers the AP 2. In some embodiments, the powerline interface 9 is further configured to place network data such as voice signals on the AC power line 11.

According to another aspect, a system for communicating a temperature control signal to the Internet is provided. The system includes a wireless access point (AP) 2 comprising: a radio transceiver 7 configured to receive signals from climate control equipment 3 and to receive and transmit voice and data signals from and to terminal devices; a thermostat 5 configured to measure temperature; and a processor 6 configured to generate a temperature control signal based on the measured temperature. The system also includes a climate control unit 3 configured to receive the temperature control signal from the AP 2 and communicate the temperature control signal to electrical power lines 18 exterior to the climate control unit 3.

According to this aspect, in some embodiments, the system further includes a communication device 14, 15, 16 configured to receive the temperature control signal from the electrical power lines 18 and direct temperature information to the Internet, the temperature information based at least in part on the temperature control signal. In some embodiments, the system further includes a user interface 8 adapted to enable control of a temperature setting of the thermostat 5. In some embodiments, the system further includes a powerline interface 9 configured to couple the temperature control signals to the climate control equipment 3. In some embodiments, the powerline interface 9 is configured to couple electrical power to the AP. In some embodiments, the powerline interface 9 places the temperature control signal on an alternating current (AC) power line 11 that powers the AP 2.

According to yet another aspect, a radio/thermostat device is provided. The device includes a thermostat 5 configured to measure temperature and produce a signal indicative of the measured temperature. The device also includes a processor 6 configured to: receive the signal indicative of the measured temperature; compare the signal indicative of the measured temperature to a temperature setting signal; and generate a temperature control signal to direct a climate control unit 3 to one of increase or decrease a temperature based on the comparison. The device also includes a radio frequency (RF) transceiver 7 to transmit and receive voice and data signals from remote devices. The device further includes a powerline interface 9 configured to receive power to energize the radio/thermostat device and to transmit the temperature control signal to the climate control unit 3.

According to this aspect, in some embodiments, the powerline interface 9 is further configured to transmit voice signals over a powerline 11 that carries the temperature control signal. In some embodiments, the processor 6 that generates the temperature control signal is further configured to encode and decode voice signals.

In some embodiments, a smart device 20 is modified to include a wireless access point 24. For example, a smart outlet, smart light bulb, smart smoke detector, or other smart device is a device that communicates with the Internet and can be monitored and controlled at a remote location via the Internet. For example, an intensity and color of light from a smart light bulb can be controlled remotely from a computer terminal or I-phone when the smart light bulb is in the vicinity of a router via a transceiver 22 of the smart device 20. By including a wireless access point 24 with the smart device, the functionality of the smart device is altered from being a client device to being part of the network infrastructure, receiving and transmitting network data from and to other client devices. This enhances the connectivity and reliability of the Wi-FI network by providing additional access points for relaying network data. In some embodiments, a plurality of AP-equipped smart devices may be employed in a mesh network such that the AP-equipped smart devices communicate with each other and with a router or by wireline to the Internet.

Thus, some embodiments include a combined smart device/wireless access point that includes a smart device configured to enable remote control of an attribute of the smart device and a wireless access point configured to relay data packets to and from the Internet and to and from a wireless station, such as another smart device. In some embodiments, the smart device and wireless access point share a common transceiver.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A wireless access point (AP) configured to transmit temperature control signals to climate control equipment and to receive and transmit network data from and to a terminal device, the AP comprising:
a thermostat configured to measure temperature; and
a processor configured to generate temperature control signals based on the measured temperature, the temperature control signals to be communicated to the climate control equipment; and
a radio transceiver configured to receive and transmit voice signals from and to a terminal device.

2. The AP of claim 1, further comprising a user interface adapted to enable input of a temperature setting and wherein the processor is further configured to compare the temperature setting to the measured temperature to generate the temperature control signals.

3. The AP of claim 1, further comprising a powerline interface configured to couple the temperature control signals to the climate control equipment.

4. The AP of claim 3, wherein the powerline interface is further configured to couple electrical power to the AP.

5. The AP of claim 3, wherein the powerline interface is further configured to place the temperature control signals on an alternating current (AC) power line that powers the AP.

6. The AP of claim 5, wherein the powerline interface is further configured to place voice signal on the AC power line.

7. A system for communicating a temperature control signal to the Internet, the system comprising:
a wireless access point (AP) comprising:
a radio transceiver configured to receive signals from climate control equipment and to receive and transmit network data signals from and to terminal devices;
a thermostat configured to measure temperature; and
a processor configured to generate a temperature control signal based on the measured temperature; and
a climate control unit configured to receive the temperature control signal from the AP and communicate the temperature control signal to electrical power lines exterior to the climate control unit.

8. The system of claim 7, further comprising a communication device configured to receive the temperature control signal from the electrical power lines and direct temperature information to the Internet, the temperature information based at least in part on the temperature control signal.

9. The system of claim 7, further comprising a user interface adapted to enable control of a temperature setting of the thermostat.

10. The system of claim 7, further comprising a powerline interface configured to couple the temperature control signals to the climate control equipment.

11. The system of claim 10, wherein the powerline interface is configured to couple electrical power to the AP.

12. The system of claim 10, wherein the powerline interface places the temperature control signal on an alternating current (AC) power line that powers the AP.

13. A radio/thermostat device, comprising:
a thermostat configured to measure temperature and produce a signal indicative of the measured temperature;
a processor configured to:
receive the signal indicative of the measured temperature;
compare the signal indicative of the measured temperature to a temperature setting signal; and
generate a temperature control signal to direct a climate control unit to one of increase or decrease a temperature based on the comparison; and
a radio frequency (RF) transceiver to transmit and receive network data from remote devices; and
a powerline interface configured to receive power to energize the radio/thermostat device and to transmit the temperature control signal to the climate control unit.

14. The device of claim 13, wherein the powerline interface is further configured to transmit voice signals over a powerline that carries the temperature control signal.

15. The device of claim 14, wherein the processor that generates the temperature control signal is further configured to encode and decode voice signals.

16. A combined smart device/wireless access point, comprising:
a smart device configured to enable remote control of an attribute of the smart device; and
a wireless access point configured to relay data packets to and from the Internet and to and from a wireless station, such as another smart device.

17. The combined smart device/wireless access point of claim 16, wherein the smart device and wireless access point share a common transceiver.
